(19) United States
(12) Patent Application Publication
(10) Pub. No.: US 2025/0373998 A1
(43) Pub. Date: Dec. 4, 2025

(54) MULTI-SOURCE AUDIO COMMUNICATION SYSTEM

(71) Applicant: Microsoft Technology Licensing, LLC, Redmond, WA (US)

(72) Inventors: Ali HAJY, Deming, WA (US); Anders Edgar KLEMETS, Redmond, WA (US)

(73) Assignee: Microsoft Technology Licensing, LLC, Redmond, WA (US)

(21) Appl. No.: 18/678,202

(22) Filed: May 30, 2024

(51) Int. Cl. H04S 7/00; G10L 15/00; H04N 7/15

(52) U.S. Cl. CPC H04S 7/302; G10L 15/005; H04N 7/15; H04S 2400/11

(57) ABSTRACT

A method, system, and computer-readable medium for providing a selectable virtual listening position in a hybrid meeting (e.g., a meeting with both virtual and in-person participants). An audio map of a local meeting location is provided to connected devices. A remote participant selects a position on the audio map as a virtual listening position in the local meeting location, which is correlated to one or more microphones in the local meeting location. Audio captured by the one or more correlated microphones is prioritized for the remote participant, where prioritizing the audio causes the audio to be output by the remote participant's device at a higher level (e.g., volume) than audio captured by other microphones in the local meeting location. Thus, the remote participant is provided a user experience that enables the remote participant to engage in a conversation occurring amongst one or more in-person attendees/participants at the local meeting location.

### BACKGROUND

Virtual meetings are an effective medium for enabling participants to interact and communicate remotely via a virtual meeting platform. A hybrid meeting combines elements of in-person meetings and virtual meetings, where some participants (local participants) attend the hybrid meeting in person at a local meeting location and one or more remote participants connect to the hybrid meeting using the virtual meeting platform. Sometimes in hybrid meetings, a side-chat or small group-discussion occurs between multiple local participants. For instance, a side-chat may transpire during a break in a meeting, or a meeting may include breakout sessions where small groups discuss certain topics. In such situations, local participants and remote participants may experience different levels of immersion in the hybrid meeting. For instance, remote participants may be limited in participating in a side-chat and/or small group-discussion, as opposed to local participants who are able to move around the local meeting location and interact with other local participants.

It is with respect to these and other considerations that examples have been made. In addition, although relatively specific problems have been discussed, it should be understood that the examples should not be limited to solving the specific problems identified in the background.

### SUMMARY

This summary is provided to introduce a selection of concepts in a simplified form that are further described below in the Detailed Description section. This summary is not intended to identify key features or essential features of the claimed subject matter, nor is it intended as an aid in determining the scope of the claimed subject matter.

The present technology provides for a system, method, and computer-readable medium for providing a selectable virtual listening position in a hybrid meeting (e.g., a meeting with both virtual and in-person participants). In examples, an audio map of a local meeting location is provided in a user interface to participant computing devices connected to a virtual meeting session. Via the audio map, a remote participant is able to select a position on the audio map as a virtual listening position in the local meeting location. The selected virtual listening position is correlated (e.g., assigned) to one or more microphones in the local meeting location. Audio captured by the one or more microphones correlated to the selected virtual listening position is prioritized for the remote participant, where prioritizing the audio causes the audio to be output by the remote participant's computing device at a higher level (e.g., volume or clarity) than audio captured by other microphones in the local meeting location. Thus, the remote participant is provided a user experience that enables the remote participant to engage in (e.g., listen in on and/or provide verbal communication in) a conversation occurring amongst one or more in-person attendees/participants at the local meeting location. Aspects of the present disclosure provide a selectable listening position enhances usability of virtual meeting platforms by increasing a level of immersion for remote participants of hybrid meetings. Additionally, prioritized audio may be provided to one or more services for additional processing, such as a language translation service. Thus, a remote participant is provided with content from a hybrid meeting that is in a format (e.g., language) tailored to the remote participant.

The details of one or more aspects are set forth in the accompanying drawings and description below. Other features and advantages will be apparent from a reading of the following detailed description and a review of the associated drawings. It is to be understood that the following detailed description is explanatory only and is not restrictive of the invention as claimed.

### BRIEF DESCRIPTION OF THE DRAWINGS

The accompanying drawings, which are incorporated in and constitute a part of this disclosure, illustrate various aspects of the present invention. In the drawings:

FIG. 1 depicts a system for providing a selectable listening position in a hybrid meeting according to a first embodiment.

FIG. 2 depicts a system for providing a selectable listening position in a hybrid meeting according to a second embodiment.

FIG. 3A depicts an audio map of a meeting location according to an example.

FIG. 3B depicts a first example method of selecting a virtual listening position using the audio map of FIG. 3A.

FIGS. 3C and 3D depict a second example method of selecting a virtual listening position using the audio map of FIG. 3A.

FIG. 3E depicts an example method of muting a microphone via an audio map.

FIG. 3F depicts an audio map of a meeting location according to another example.

FIG. 4 depicts an example method for providing a selectable listening position in a hybrid meeting.

FIG. 5 is a block diagram illustrating example physical components of a computing device with which aspects of the invention may be practiced.

### DETAILED DESCRIPTION

The following detailed description refers to the accompanying drawings. Wherever possible, the same reference numbers are used in the drawing and the following description to refer to the same or similar elements. While aspects of the invention may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the invention, but instead, the proper scope of the invention is defined by the appended claims. Examples may take the form of a hardware implementation, or an entirely software implementation, or an implementation combining software and hardware aspects. The following detailed description is, therefore, not to be taken in a limiting sense.

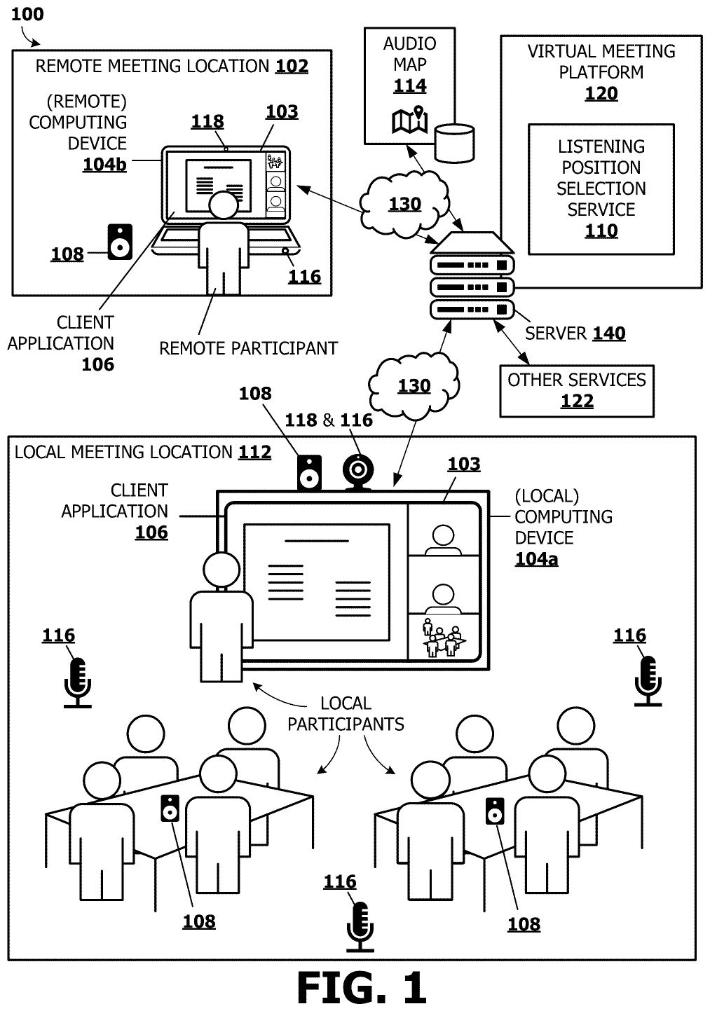

FIG. 1 depicts a first embodiment of an example system 100 for providing a selectable listening position in a hybrid meeting. The system 100 includes a virtual meeting platform 120 and a plurality of client computing devices 104a and 104b (collectively referred to as computing devices 104). The computing devices 104 may take a variety of forms, including desktop computers, laptops, tablets, smart phones, wearable devices, gaming devices/platforms, virtualized reality devices/platforms (e.g., virtual reality (VR), augmented reality (AR), mixed reality (MR)), etc. Each of the computing devices 104 includes a client application 106 that allows for participation in, or connection to, a virtual meeting session hosted by the virtual meeting platform 120. The client application 106 may include a desktop application, mobile application, or a web browser. The virtual meeting platform 120 is a software-based service or application that provides online collaboration and communication via hosting a virtual meeting session between dispersed participants. In some implementations, the virtual meeting platform 120 is cloud-based (e.g., located on a server 140 in a distributed computing network 130, such as the Internet). In some implementations, the virtual meeting platform 120 provides various features for communicating, such as video conferencing, audio conferencing, chat messaging, screen sharing, and/or other collaborative features to facilitate communication among participants who are in different physical locations. During the virtual meeting, audio and/or video is communicated between the computing devices 104 and the virtual meeting platform 120. In some implementations, a virtual meeting session has various associated meeting details, such as a meeting title, a date and time of the meeting, a list of participants, a virtual meeting session link, duration of the meeting, and/or a meeting organizer/host. The virtual meeting session link is a web address that provides remote participants access to the virtual meeting session.

In some examples, the virtual meeting session is a hybrid meeting that combines elements of an in-person meeting and a virtual meeting. For instance, in a hybrid meeting, some participants (referred to herein as local participants) attend the meeting in person at a local meeting location 112 and one or more remote participants connect to the meeting from one or more remote meeting locations 102 using the virtual meeting platform 120. The example system implementation depicted in FIG. 1 includes local participants connected to the virtual meeting session via a local computing device 104a operating at the local meeting location 112 and a remote participant connected to the virtual meeting session via a remote computing device 104b operating at a remote meeting location 102. The local meeting location 112 may include a meeting room, conference room, office space, or other place where one or more local participants can gather to have an in-person meeting. The remote location 102 is a location other than the local meeting location 112 (e.g., in a next room or at another premises).

According to examples, the local meeting location 112 includes a plurality of (local) microphones 116 located in various positions in the local meeting location 112 and that are connected to the local computing device 104a. The microphones 116 capture audio in the local meeting location 112, which is transmitted by the client application 106 on the local computing device 104a to the virtual meeting platform 120 and further to remote participants connected to the virtual meeting session. The audio may be played by one or more speakers 108 connected to the remote computing device 104b. In examples, audio captured by a microphone 116 at the local meeting location 112 includes spoken communication provided by one or more meeting participants (e.g., one or more local participants). In further examples, each microphone 116 captures audio within an audio zone, where the audio zone is a spatial area within which the microphone 116 can effectively capture audio. Characteristics (e.g., size and shape) of an audio zone may be based on predetermined shape and size, default microphone specifications (e.g., sensitivity, impedance, and/or pickup pattern) or known specifications of the associated microphone 116. For instance, the effective capture of audio in an audio zone by a microphone 116 is related to a minimum threshold level of sound that is captured at a distance from the microphone 116. In examples, the local meeting location 112 includes a plurality of audio zones. Different local participants at the local meeting location 112 may be located in different audio zones, where spoken communication provided by a first local participant may be received via a first microphone 116 in a first audio zone and spoken communication provided by a second local participant may be received via a second microphone 116 in a second audio zone. In some examples, two or more audio zones may overlap. For instance, the first local participant may be positioned in a spatial area where audio is captured by the first and second microphones 116.

In some examples, the remote computing device 104b further includes or is connected to a (remote) microphone 116 that captures audio (e.g., spoken communication) provided by the remote participant. Audio provided by the remote participant may be transmitted by the client application 106 operating on the remote computing device 104b to the virtual meeting platform 120 and further to the local computing device 104a and/or other devices connected to the virtual meeting session. For instance, audio provided by the remote participant may be transmitted to and played on one or more speakers 108 included in or connected to the local computing device 104a.

In some examples, one or more computing devices 104 connected to the virtual meeting session include or are connected to one or more cameras 118. For instance, a (local) camera 118 connected to the local computing device 104a may capture video/images of one or more local participants, which are provided to the virtual meeting platform 120 and transmitted to the remote computing device 104b and other computing devices 104 connected to the virtual meeting session. Similarly, a (remote) camera 118 connected to the remote computing device 104b may capture video/images of the remote participant, which are provided to the virtual meeting platform 120 and transmitted to the local computing device 104a and other computing devices 104 connected to the virtual meeting session. The computing devices 104 further include or are connected to one or more screens 103 on which a user interface (UI) of the client application 106 is displayed. In examples, the client application UI presents various meeting-related information, such as video/images captured by the cameras 118 and/or content shared by a participant (e.g., a document, a screen sharing activity, or a presentation), a transcript of captured audio, chat messages between participants, etc.

According to examples, the system includes a listening position selection service 110 that allows a participant, such as a remote participant, to select a virtual listening position in the local meeting location 112 from which to participate in a virtual meeting session. The listening position selection service 110 may be provided by the virtual meeting platform 120 and/or the client application 106. In examples, the virtual listening position corresponds to a physical location in the local meeting location 112. Selectable virtual listening positions allows the remote participant to virtually explore listening into the meeting from different positions in the local meeting location 112. Consider, for example, a hybrid meeting where a side-chat or small group-discussion occurs between a group of local participants in a particular audio zone. The remote participant may notice (e.g., from video of the local meeting location 112) a side-chat or small group-discussion taking place in the local meeting location 112 in which the remote participant wants to participate (e.g., at a minimum, listen to the side-chat or small group-discussion). Thus, a virtual listening position proximate to the side-chat or small group-discussion may be selected by the remote participant. By contrast, a default listening position for a remote participant is a composite of the audio captured by all the microphones 116 in the local meeting location 112.

In an example implementation, an audio map 114 is obtained and provided to the remote participant in the client application Ul for enabling the remote participant to select a desired virtual listening position. The audio map 114 is a two-dimensional (2D) representation of the local meeting location 112 and shows a physical layout of the local meeting location 112. In different implementations, various levels of details are included in the audio map 114, where in some examples the audio map 114 may show the perimeter of the local meeting location 112 and in other examples, additional details are included, such as a seating arrangement, audio/video equipment, and/or other features of the local meeting location 112. According to an aspect, the audio map 114 includes location data (e.g., coordinates) of the physical locations of the microphones 116 in the local meeting location 112. In some examples, the audio map 114 is generated by the virtual meeting platform 120 or a meeting resource service in communication with the virtual meeting platform 120 based on properties about the local meeting location 112 (e.g., dimensions of the room, locations (coordinates) of microphones 116, locations of speakers 108, and/or other properties). For instance, physical dimensions of the local meeting location 112 are translated into the graphical representation of the local meeting location 112. In examples, this translation involves calculating a scale of the audio map 114 based on the size (e.g., physical dimensions) of the local meeting location 112. The locations of microphones 116, speakers 108, and/or other equipment are graphically represented on the audio map 114 in one or more layers. These locations are determined by converting their physical locations (e.g., coordinates) in the local meeting location 112 into corresponding positions on the audio map 114. In some examples, this conversion involves calculating relative distances and angles between the equipment and reference points in the local meeting location 112. In further examples, manual input of properties about the local meeting location 112 is received (e.g., from a user of client application 106) by the virtual meeting platform 120 or associated service to generate the audio map 114 based on the received properties. In some examples, the audio map 114 further includes graphical representations of audio zones associated with the microphones 116. In examples, the graphical representations of the audio zones are based on translating specified or calculated characteristics (e.g., size and shape based on sensitivity, impedance, and/or pickup pattern of the associated microphones 116) of an audio zone into corresponding positions on the audio map 114. In some examples, indications of the locations of the microphones 116 and/or associated audio zones are not displayed. In further examples, the audio map 114 includes location data (e.g., coordinates) of the physical locations of speakers 108 in the local meeting location 112. In yet further examples, a coverage area of the speakers 108 is also represented on the audio map 114. The speaker coverage area may be calculated based on their power output and directionality.

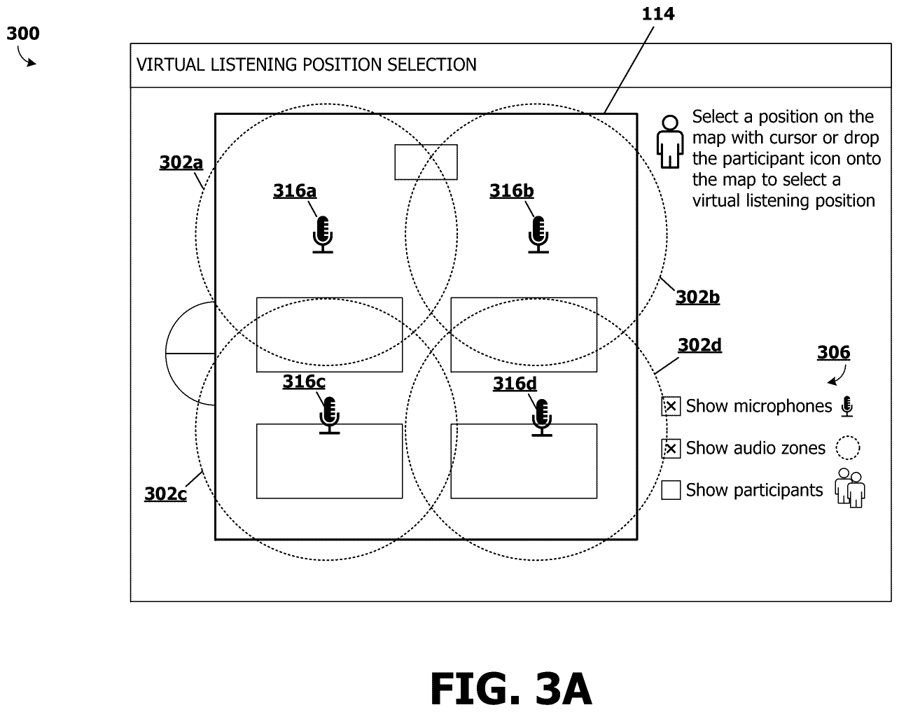

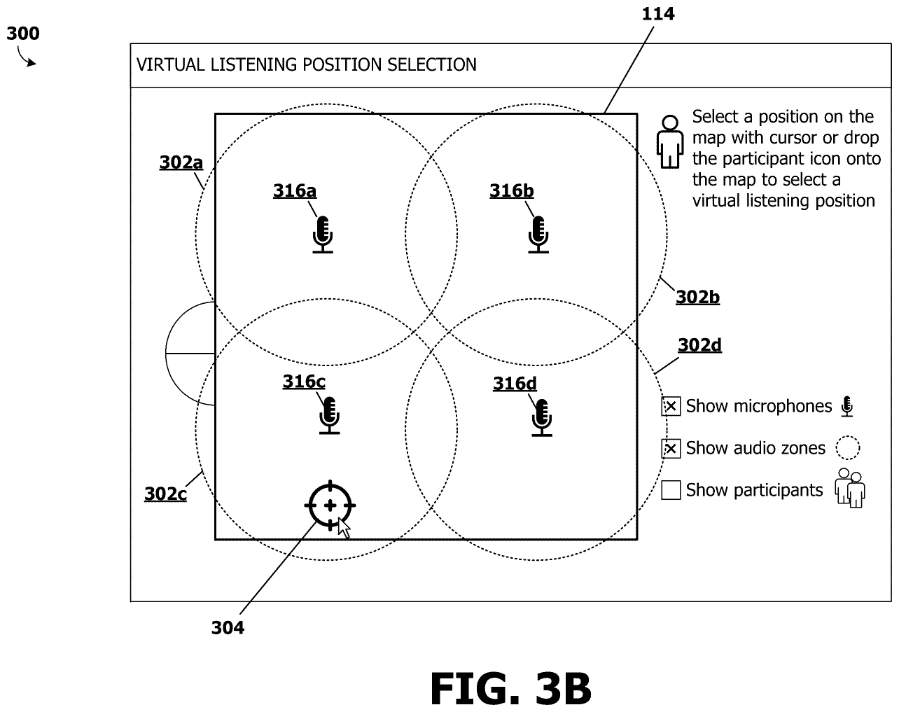

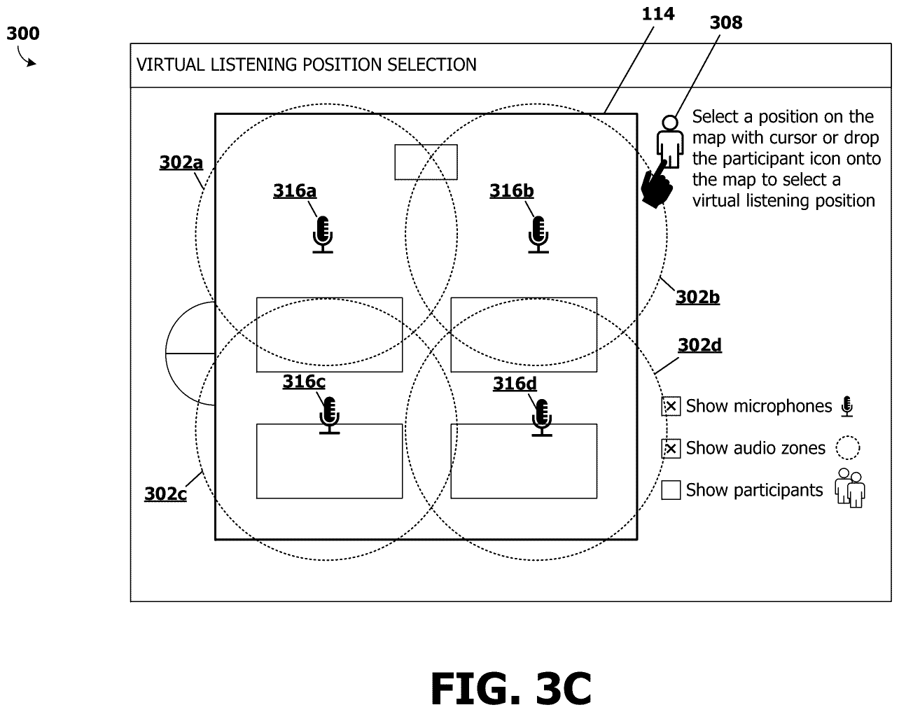

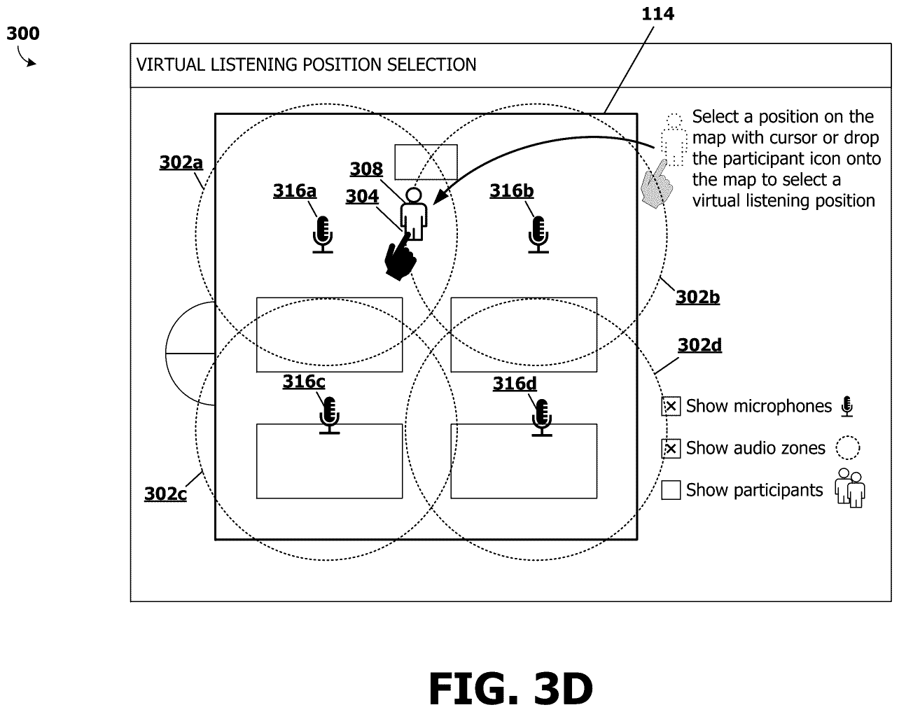

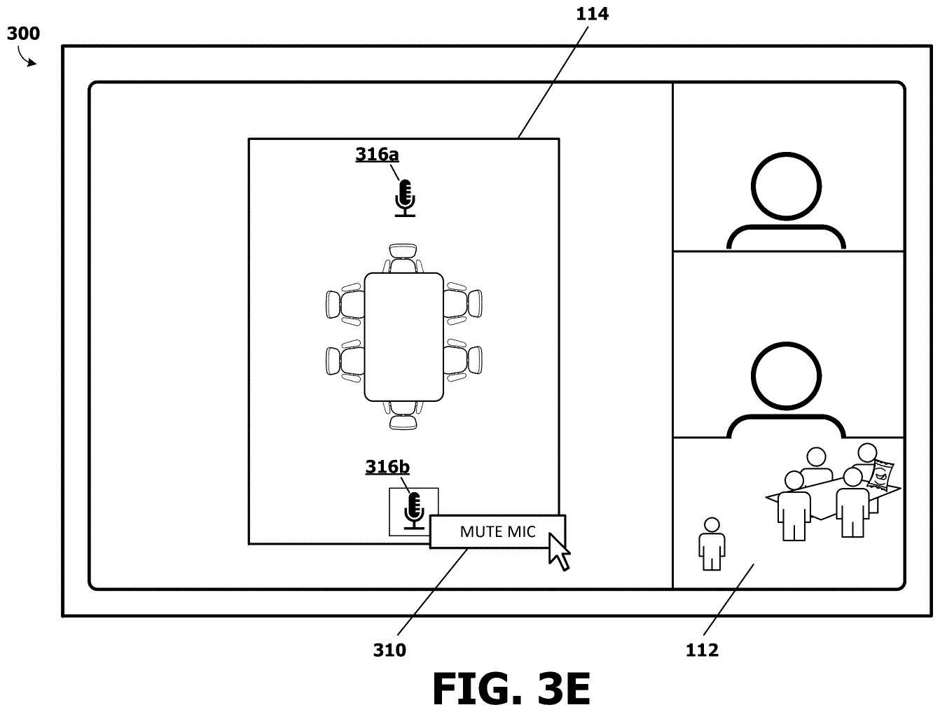

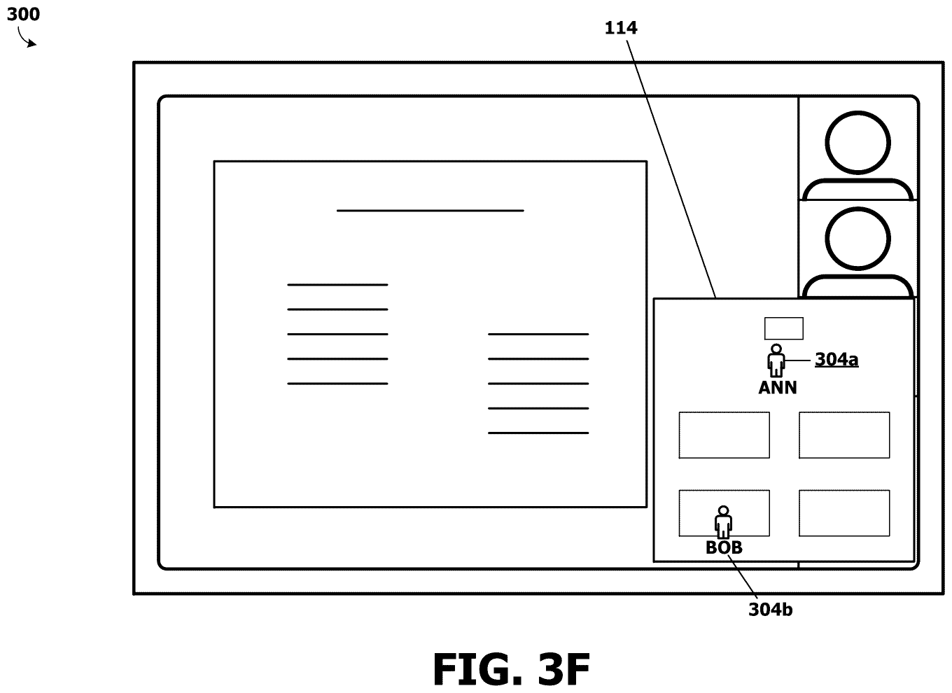

In an example implementation, the audio map 114 includes an interactive interface that allows a user (e.g., the remote participant) to select a specific point or area on the audio map 114 corresponding to a physical location in the local meeting location 112 as a virtual listening position. Selection of the virtual listening position may be performed by clicking on the specific point on the audio map 114, moving an icon representing the remote participant onto the point, or via another method. The audio map 114 is described in further detail below with reference to FIGS. 3A-3F. In examples, the selected virtual listening position is communicated to and received by the listening position selection service 110. The listening position selection service 110 determines which audio zone the selected virtual listening position falls within by checking whether the selected virtual listening position intersects with, or is included in, the area covered by an audio zone. The listening position selection service 110 further correlates (e.g., assigns) the virtual listening position to the microphone 116 associated with the audio zone including the virtual listening position. Audio streams captured by the microphone 116 correlated (e.g., assigned) to the virtual listening position are prioritized for output to the remote participant. In examples, prioritizing audio (an audio stream) from a particular microphone 116 causes the prioritized audio to be output by a speaker 108 of the remote computing device 104b at an increased level (e.g., volume or clarity) in comparison with audio received from other microphones 116 in the local meeting location 112. Increasing clarity of audio, for instance, includes removing noise from the audio or otherwise making the audio more clear. In other implementations, prioritizing audio from a particular microphone 116 causes audio captured by the other (e.g., non-prioritized) microphones 116 in the local meeting location 112 to be muted or output by the remote computing device 104b at a decreased level/volume. Accordingly, the remote participant may be able to hear a conversation taking place proximate to the selected virtual listening position.

In some examples, the listening position selection service 110 correlates (e.g., assigns) the virtual listening position to multiple microphones 116. For instance, when the virtual listening position overlaps (e.g., is located in an area covered by) a plurality of audio zones, the listening position selection service 110 correlates (e.g., assigns) the virtual listening position to the multiple microphones 116 associated with the plurality of audio zones. In examples, the listening position selection service 110 assigns a weight to each of the multiple microphones 116. The weight is based on a distance from the virtual listening position to each microphone 116. For instance, the closer a microphone 116 is to the virtual listening position, the higher its weight. According to an aspect, a microphone 116 captures an audio stream (audio) and produces a channel of audio that is output by a speaker 108. Multiple microphones 116 can be used to capture multiple audio streams to produce multiple channels of audio that are output by different speakers 108 (e.g., surround sound) or combined into a single stream played by one or more speakers 108.

In examples, when multiple audio streams are captured by multiple microphones 116 in the local meeting location 112, the audio streams captured by the one or more microphones 116 that are correlated to the virtual listening position are prioritized based on the weights (e.g., a higher weight is correlated to a higher/increased level of volume or clarity). Some example weight correlation methods that may be used include a weighted sum method, a weighted average method, a max weight method, or another method.

In some examples, the listening position selection service 110 receives a plurality of audio streams captured by a plurality of microphones 116, prioritizes at least one audio stream based on the remote participant's selected virtual listening position, mixes the streams, and outputs a combined stream including the prioritized audio stream to the remote computing device 104b. In other examples, the listening position selection service 110 communicates information about the remote participant's selected virtual listening position to the client application 106 of the local computing device 104a, which prioritizes at least one received audio stream based on the weights, mixes the streams, and outputs a combined stream including the prioritized audio stream to the listening position selection service 110 to provide to the remote computing device 104b. In other implementations, the client application 106 of the remote computing device 104b and/or other computing devices 104 receives a plurality of audio streams, prioritizes at least one received audio stream based on the remote participant's selected virtual listening position, mixes the streams, and outputs a combined stream including the prioritized audio stream to a speaker 108.

In examples, the remote participant may select to return to a default listening position (e.g., deselect the current virtual listening position) or select a different virtual listening position. When the listening position selection service 110 receives a selection of a new virtual listening position, a correlation is made between the newly selected virtual listening position and one or more audio zones and associated microphones 116, and audio received from the microphones 116 that corresponds to the newly selected virtual listening position is prioritized for the remote participant.

In some implementations, the system 100 further includes one or more other services 122 that process prioritized audio corresponding to a virtual listening position and provide an output to the remote participant. One example other service 122 includes a transcription service that receives prioritized audio and uses speech recognition technology to convert the prioritized audio into text. In some examples, the prioritized audio is transcribed in real time (e.g., near real time) and is displayed in the client application UI 106. Another example other service 122 includes a language translation service that receives prioritized audio and translates the audio from a first language to a second language. The translated audio may be transcribed and displayed in the client application UI 106 and/or played via a speaker 108. Additional and/or alternative other services 122 are contemplated.

In some implementations, the audio map 114 is additionally displayed in the client application Ul by the local computing device 104a. When a virtual listening position is selected by a remote participant, an indication of the remote participant's virtual listening position is displayed on the audio map 114. Accordingly, local participants at the local meeting location 112 are informed that spoken communication proximate to the virtual listening position may be heard by the remote participant.

In some implementations, one or more speakers 108 are located in one or more audio zones in the local meeting location 112. When a virtual listening position is selected by a remote participant, the speaker(s) 108 in the audio zone(s) that intersect (e.g., include) the virtual listening position are prioritized for the remote participant. For instance, audio (e.g., spoken communication) provided by the remote participant is output by the prioritized speaker(s) 108, allowing for a back-and-forth conversation between the remote participant and local participants in the audio zone(s).

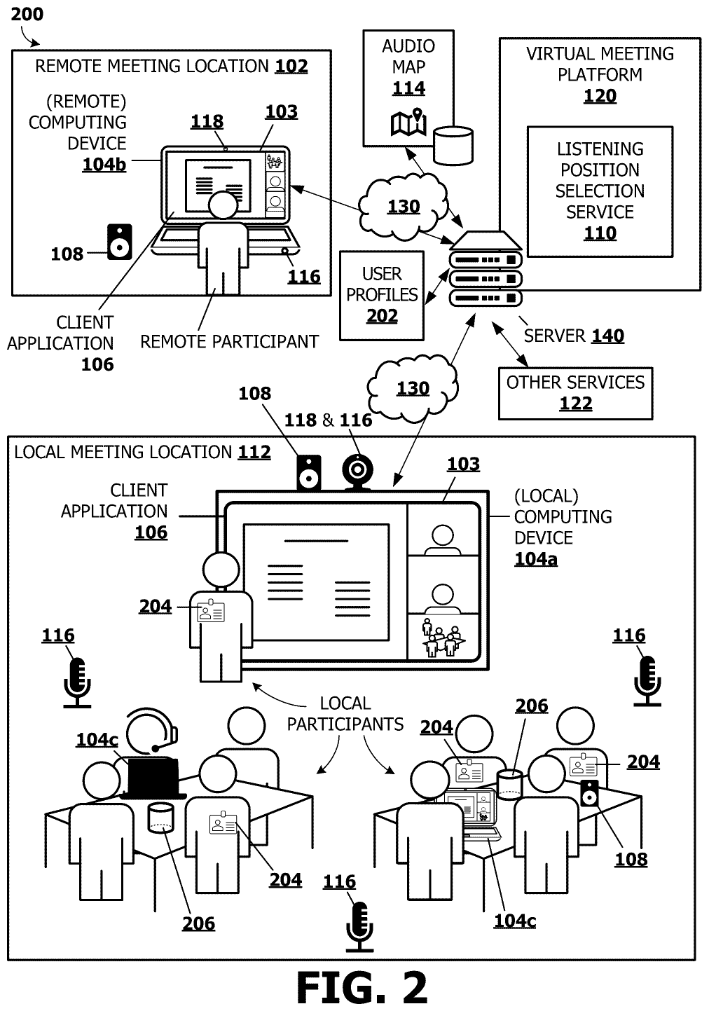

With reference now to FIG. 2, a second embodiment of an example system 200 for providing a selectable listening position in a hybrid meeting is depicted. In the second embodiment, participant presence detection is implemented at the local meeting location 112. In examples, participant presence includes identity and location information of local participants, which is included in the audio map 114. In some examples, video from one or more cameras 118 at the local meeting location 112 is analyzed to identify local participants. For instance, images of the local participants may be stored in user profiles 202 that are accessed by the listening position selection service 110. Facial recognition is performed on images of the local participants in the video and compared against the user profile images to identify the local participants and locations of the local participants in the local meeting location 112. For instance, locations of local participants in the video are mapped to physical locations in the local meeting location 112 and/or to coordinates in the audio map 114. In other examples, a voice profile of each local participant may be stored in the user profiles 202 and compared against audio captured by the microphones 116 in the local meeting location 112 to identify the local participants. The location of a local participant may be determined based on a particular microphone 116 that captures audio of the participant's voice. For instance, if audio of a local participant's voice is captured by a particular microphone 116, the local participant's location may be assigned to the particular microphone 116 or to the audio zone corresponding to the particular microphone 116. In some examples, audio of a local participant's voice is captured by multiple microphones 116. In such cases, the location of the local participant may be determined by sound localization methods (e.g., comparing and using the difference of arrival times of the audio of the local participant's voice at the multiple microphones to estimate a location of the local participant). In yet further examples, local participants may have identification (ID) badges 204 that are detected by one or more readers 206 using near-field communication technology, RFID technology, QR codes, etc. The ID badges 204 are used to identify the local participants and locations of the local participants in the local meeting location 112. In further examples, one or more local participant computing devices 104c are used by one or more local participants in the local meeting location 112 and are additionally connected to the virtual meeting session. In some examples, the one or more local participants are identified by login information provided to connect the local participant computing devices 104c to the virtual meeting session. In yet further examples, the listening position selection service 110 receives a manual input of identities and locations of the local participants in the local meeting location 112. For instance, the manual input may be received via the audio map 114 provided in the client application UI. In some implementations, in addition to the inclusion of identity and location information of local participants in the audio map 114, additional information about local participants obtained from user profiles 202 (e.g., job title, contact information) is included.

FIGS. 3A-3F include illustrations of an audio map 114 according to examples. With reference now to FIG. 3A, an example audio map 114 is shown. The example audio map 114 is displayed in a UI 300 presented by the client application 106. In some examples, the audio map 114 is displayed in response to a selection of an option to select a virtual listening position in a local meeting location 112 of a hybrid meeting. In some implementations, the audio map 114 is stored as information about the local meeting location 112. For instance, information about the local meeting location 112 and, if applicable, other meeting locations (e.g., conference rooms) is stored in a data store and accessed by the virtual meeting platform 120 such that the local meeting location 112 (or another meeting location) can be scheduled for the meeting. In some examples, meeting location information is accessed via one or more application programming interfaces (APIs). The meeting location information may include details about the local meeting location 112, such as a name of the local meeting location 112, a physical location, capacity, dimensions/layout, audio video equipment information, scheduling information, and audio map information. In some implementations, the local meeting location 112 has a plurality of built-in microphones 116 (e.g., the microphones 116 have fixed locations, such as in a ceiling, wall, or furniture), where the locations of the built-in microphones 116 are stored in the meeting location information. In other implementations, the microphones 116 are moveable (e.g., not installed in the local meeting location 112), where updated locations of the moveable microphones 116 may be configured by a user (e.g., input by the user at a time of use of the local meeting location 112) and stored in association with the local meeting location 112. In further implementations, a spatial range or coverage area of each microphone 116 (e.g., within which the microphone can effectively pick up audio) is known or estimated, and locations/coordinates of audio zones of the microphones 116 are determined based on the updated locations of the moveable microphones 116 and the known spatial ranges/coverage areas. For instance, the locations of audio zones of movable microphones 116 are updated. In some examples, the audio map 114 includes an outline of the local meeting location 112. In other examples, the audio map 114 further includes microphone icons 316a-316d (collectively, microphone icons 316) representing one or more attributes (e.g., locations and/or activity, such as whether it is currently detecting audio input) of the microphones 116a-116d in the local meeting location 112. In further examples, the audio map 114 includes audio zone icons 302a-302d (collectively, audio zone icons 302) representing the audio zones associated with the microphones 116. In some implementations, other known information is added to the audio map 114, such as locations of local participants based on participant presence information. The audio map 114 may include representations of other information about the local meeting location 112, such as seating arrangement information, locations of exits, etc. In examples, one or more options 306 are provided for enabling the remote participant to select which information is displayed on the audio map 114.

Aspects of the present disclosure provide for selection of a virtual listening position 304 on the audio map 114 by a remote participant. With reference now to FIG. 3B, a first example method of selecting the virtual listening position 304 is depicted. In FIG. 3B, the remote participant moves a pointer/cursor onto the audio map 114 and selects a position on the audio map 114 as the remote participant's selected virtual listening position 304 in the local meeting location 112. Positions on the audio map 114, and thus the selected virtual listening position 304, correspond to a physical location in the local meeting location 112. In the example shown in FIG. 3B, the selected virtual listening position 304 is determined to be located within a third audio zone (represented by a third audio zone icon 302c on the audio map 114) corresponding to a third microphone 116c in the local meeting location 112. Thus, the listening position selection service 110 correlates the virtual listening position 304 to the third microphone 116c and prioritizes, for the remote participant, audio received by the third microphone 116c.

A second example method of selecting the virtual listening position 304 is depicted in FIGS. 3C and 3D. In FIG. 3C, a participant icon 308 representing the remote participant is provided in the UI 300 and selected by the remote participant. As shown in FIG. 3D, the participant icon 308 is dragged by the remote participant onto the audio map 114 and dropped on a position on the audio map 114 corresponding to a physical location in the local meeting location 112. The selected position on the audio map 114 is received by the listening position selection service 110 and determined as the remote participant's selected virtual listening position 304 in the local meeting location 112. In the example shown in FIG. 3D, the selected virtual listening position 304 is determined to be located within a first audio zone (represented by a first audio zone icon 302a) corresponding to a first microphone 116a and a second audio zone (represented by a second audio zone icon 302b) corresponding to a second microphone 116b. Accordingly, the listening position selection service 110 correlates the virtual listening position 304 to the first 116a and second microphones 116b. As depicted in FIG. 3D, the selected virtual listening position 304 is closer to the first microphone 116a. Thus, the listening position selection service 110 correlates a higher weight to the first microphone 116a and a lower weight to the second microphone 116b. In an example, the listening position selection service 110 prioritizes, for the remote participant, audio received by the first microphone 116a according to the higher weight and audio received by the second microphone 116b according to the lower weight. Weights may be applied via one or a combination of methods (e.g., weighted sum method, a weighted average method, a max weight method). Other methods of selecting a virtual listening position are contemplated, such as via a selection of a microphone icon 316 or audio zone icon 302 displayed on the audio map 114.

In some implementations, audio captured by one or more microphones 116 is prioritized via a selection to mute another one or more microphones 116 in the local meeting location 112. For instance, and with reference now to FIG. 3E, background noise in an audio zone may be picked up by a second microphone 116b in the local meeting location 112 (e.g., a local participant with a bag of chips next to the second microphone 116b). The remote participant may have difficulty hearing another local participant and may desire to mute the second microphone 116b. In examples, microphone icons 316 displayed on the audio map 114 are selectable and have one or more associated options 310. For instance, when a second microphone icon 316b corresponding to the second microphone 116b is selected by the remote participant, a mute option 310 may be presented. When selected, the listening position selection service 110 may mute, for the remote participant, audio captured by the second microphone 116b, and thus prioritizes audio captured by other microphones 116 (a first microphone 116a) in the local meeting location 112.

In some implementations, and as depicted in FIG. 3F, the audio map 114 includes indications of virtual listening positions 304a and 304b of one or more remote participants connected to the virtual meeting session. For instance, the example audio map 114 depicted in FIG. 3F may be displayed in the UI 300 on the local computing device 104a and/or one or more remote computing devices 104b. The indications of virtual listening positions 304a and 304b provide information to the meeting participants about whether a remote participant may be listening in on a conversation occurring in the local meeting location 112.

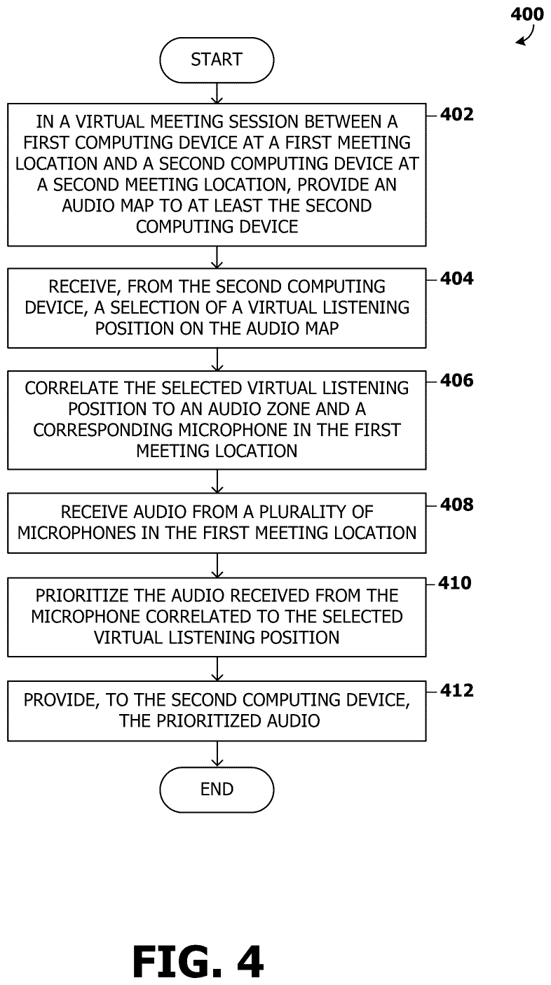

FIG. 4 is a flow diagram depicting an example method 400 for providing a selectable listening position in a hybrid meeting. The method 400 starts at operation 402, where a virtual meeting session of the hybrid meeting is initiated between a first computing device 104a and a second computing device 104b. For example, the first computing device 104a is a local computing device at a first meeting location (e.g., a local meeting location 112) and the second computing device 104b is a remote computing device used by a remote participant at a second meeting location (e.g., a location remote from the first meeting location). In examples, a plurality of local participants attends the hybrid meeting in person at the first meeting location. At operation 402, an audio map 114 of the first meeting location is accessed (e.g., from storage) and is provided to at least the second computing device 104b. In examples, the audio map 114 is a visual representation of the first meeting location. The audio map 114 may show a physical layout of the first meeting location and, in some examples, includes various details or features of the first meeting location based on known information about the first meeting location. Positions on the audio map 114 correspond to physical locations in the first meeting location. The audio map 114 further includes location data (e.g., coordinates) of the locations of a plurality of microphones 116 and/or associated audio zones of the microphones 116, which may or may not be displayed. In some implementations, participant presence information is detected via one or more presence detection methods (e.g., facial recognition, voice recognition, user input) and indicators of identities and/or locations of one or more local participants are included in the audio map 114. In examples, the audio map 114 is displayed in a client application UI 300 on at least the second computing device 104b. In further examples, the audio map 114 is further displayed in a client application UI 300 on the first computing device 104a.

At operation 404, an indication of a selection of a virtual listening position 304 is received from the second computing device 104b. The selection may be made via selecting a position on the audio map 114 with a cursor, dropping a participant icon 308 onto the position, selecting a microphone icon 316 or a corresponding audio zone icon 302 displayed on the audio map 114, or via another selection method. In some examples, the audio map 114 provides a visual indication of a side conversation occurring. For example, a visual attribute of one or a combination of a microphone icon 316 or an audio zone icon 302 corresponding to a potential virtual listening position may change (e.g., blink, become highlighted or enlarged, or change color) to indicate that audio is being captured. In other examples, video of first meeting location captured by one or more cameras 118 at the first meeting location is presented in the client application UI 300 on the second computing device 104b. The video may provide the remote participant a view of locations of local participants in the first meeting location. For instance, the remote participant may view the video to determine whether a side-chat or small group-discussion is occurring in the first meeting location that the remote participant wants to engage in a physical location in the first meeting location where the side-chat or small group-discussion is occurring. The remote participant may select the virtual listening position 304 based on information ascertained from the audio map 114 and/or video.

At operation 406, the selected virtual listening position 304 is correlated to one or more audio zones associated with one or more microphones 116 in the first meeting location. In some examples, the selected virtual listening position 304 is located in one audio zone and is correlated to one microphone 116. In other examples, the selected virtual listening position 304 intersects a plurality of audio zones and is correlated to a plurality of microphones 116, where the correlation includes applying a weight to each of the plurality of microphones 116 based on a distance from a physical location in the first meeting location that corresponds to the selected virtual listening position 304 to each of the plurality of microphones 116. For instance, the correlation method includes applying a weight to each microphone 116 based on its distance from a physical location in the local meeting location 112 that corresponds to the virtual listening position 304. Weighting is used to adjust the influence or importance of different microphones 116 in the final audio output and may be implemented using weighted sum method, a weighted average method, a max weight method, or another method. As an example, a first microphone 116 closer to the virtual listening position 304 is assigned a higher weight (more influence) than a second microphone 116 further away, which would have a lower weight (less influence). The weight applied to the first microphone 116 causes audio captured by the first microphone 116 to be output at a higher volume and/or with increased clarity to the remote participant over audio captured by the second microphone 116.

At operation 408, audio captured by one or more microphones 116 in the first meeting location is received. In some examples, the audio includes spoken communication provided by one or more local participants.

At operation 410, the audio received from the one or more microphones 116 correlated to the selected virtual listening position 304 is prioritized for the second computing device 104b and provided to the second computing device 104b at operation 412. In examples, prioritization of the audio causes the prioritized audio to be output by a speaker 108 of the second computing device 104b at an increased level (e.g., volume or clarity) in comparison with audio received from other microphones 116 in the first meeting location. In examples, when audio from more than one microphone 116 is prioritized, the audio is prioritized according to applied weights, where higher-weighted audio is output at an increased level over lower-weighted audio. In some examples, audio received from other microphones 116 that are not correlated to the selected virtual listening position 304 is muted or otherwise output at a reduced level. Thus, the remote participant may be able to engage in the side-chat or small group-discussion taking place near the selected virtual listening position 304. In some implementations, an indication of the remote participant's virtual listening position 304 is displayed on the audio map 114. In further examples, the remote participant may choose to select a different virtual listening position 304 and the method 400 may return to operation 404, where a selection of a new virtual listening position 304 is received.

As should be appreciated from the foregoing, the present technology provides multiple technical benefits and solutions to technical problems. For instance, participating remotely in a hybrid meeting generally includes various limitations in comparison to participating in-person, such as participation in a side-chat and/or small group-discussion occurring at the local meeting location 112 between local participants. The present technology enhances usability of virtual meeting platforms by increasing a level of immersion for remote participants of hybrid meetings. In examples, the listening position selection service 110 provides a remote participant access to an audio map 114 of the local meeting location 112 and allows the remote participant to select a position on the audio map 114 as the remote participant's virtual listening position 304. The listening position selection service 110 correlates the selected virtual listening position 304 to one or more microphones 116 in the local meeting location 112 based on distance from the selected virtual listening position 304 to the microphones 116 and prioritizes the audio captured by those microphones 116 for the remote participant. The prioritized audio is output by the remote participant's computing device 104b at an enhanced level (e.g., volume or clarity) compared to audio captured by other microphones 116 in the local meeting location 112. Thus, the remote participant is provided a user experience that enables the remote participant to engage in (e.g., listen in on and/or provide verbal communication in) a conversation occurring amongst one or more in-person attendees/participants of the hybrid meeting at the local meeting location 112. Additionally, prioritized audio may be provided to one or more services for additional processing, such as a language translation service. Thus, a remote participant is provided with content from a hybrid meeting that is in a format (e.g., language or dialect) tailored to the remote participant.

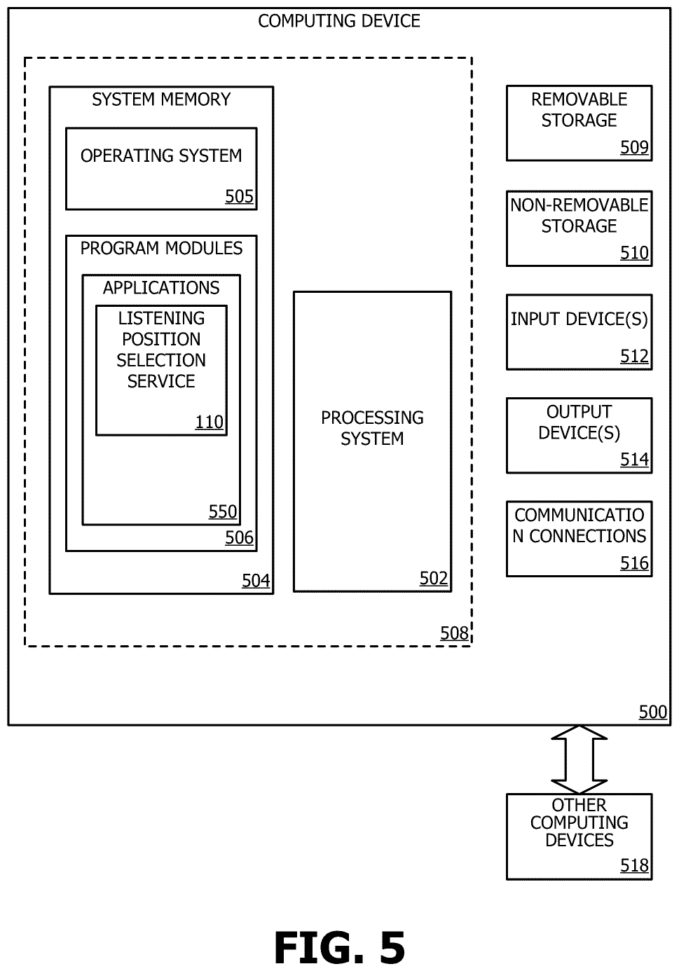

FIG. 5 is a block diagram illustrating physical components (e.g., hardware) of a computing device 500 with which aspects of the disclosure may be practiced. The computing device components described below may be suitable for the computing devices and systems described above. In a basic configuration, the computing device 500 includes at least one processing system 502 and a system memory 504. Depending on the configuration and type of computing device, the system memory 504 comprises volatile storage (e.g., random access memory (RAM)), non-volatile storage (e.g., read-only memory (ROM)), flash memory, or any combination of such memories.

The system memory 504 includes an operating system 505 and one or more program modules 506 suitable for running software application 520, such as the listening position selection service 110 or other of the one or more components supported by the systems described herein. The operating system 505, for example, is suitable for controlling the operation of the computing device 500.

Furthermore, embodiments of the disclosure may be practiced in conjunction with a graphics library, other operating systems, or any other application program and is not limited to any particular application or system. This basic configuration is illustrated in FIG. 5 by those components within a dashed line 508. The computing device 500 may have additional features or functionality. For example, the computing device 500 may also include additional data storage devices (removable and/or non-removable) such as, for example, magnetic disks, or optical disks. Such additional storage is illustrated in FIG. 5 by a removable storage device 507 and a non-removable storage device 510.

As stated above, a number of program modules and data files may be stored in the system memory 504. While executing on the processing system(s) 502, the program modules 506 (e.g., application 520) may perform processes including the aspects described herein. Other program modules that may be used in accordance with aspects of the present disclosure include electronic mail and contacts applications, word processing applications, spreadsheet applications, database applications, slide presentation applications, drawing or computer-aided application programs, etc.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. For example, embodiments of the disclosure may be practiced via a system-on-a-chip (SOC) where each or many of the components illustrated in FIG. 5 may be integrated onto a single integrated circuit. Such an SOC device may include one or more processing systems/units, graphics units, communications units, system virtualization units and various application functionality all of which are integrated (or “burned”) onto the chip substrate as a single integrated circuit. When operating via an SOC, the functionality described herein with respect to the capability of a client to switch protocols, may be operated via application-specific logic integrated with other components of the computing device 500 on the single integrated circuit (chip). Embodiments of the disclosure may also be practiced using other technologies capable of performing logical operations such as, for example, AND, OR, and NOT, including mechanical, optical, fluidic, and quantum technologies. In addition, embodiments of the disclosure may be practiced within a general-purpose computer or in any other circuits or systems.

The computing device 500 also has one or more input device(s) 512 such as a keyboard, a mouse, a pen, a sound or voice input device, a touch or swipe input device, etc. The output device(s) 514 such as a display, speakers, a printer, etc. may also be included. The aforementioned devices are examples and others may be used. The computing device 500 may include one or more communication connections 516 allowing communications with other computing devices 550. Examples of suitable communication connections 516 include radio frequency (RF) transmitter, receiver, and/or transceiver circuitry; universal serial bus (USB), parallel, and/or serial ports.

The term computer readable media as used herein may include computer storage media. Computer storage media may include volatile and nonvolatile, removable and non-removable media implemented in any method or technology for storage of information, such as computer readable instructions, data structures, or program modules. The system memory 504, the removable storage device 507, and the non-removable storage device 510 are all computer storage media examples (e.g., memory storage). Computer storage media includes RAM, ROM, electrically erasable ROM (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information, and which can be accessed by the computing device 500. Any such computer storage media may be part of the computing device 500. Computer storage media does not include a carrier wave or other propagated or modulated data signal.

Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, communication media may include wired media such as a wired network or direct-wired connection, and wireless media such as acoustic, RF, infrared, and other wireless media.

As will be understood from the present disclosure, one example of the technology discussed herein relates to a method, comprising: receiving an indication of a virtual meeting session between a first computing device at a first meeting location and a second computing device at a second meeting location, wherein the first computing device is connected to a plurality of microphones positioned in the first meeting location; providing, to the second computing device, an audio map of the first meeting location; receiving, from the second computing device, a selection of a first virtual listening position on the audio map; correlating the selected first virtual listening position to a first microphone of the plurality of microphones by assigning a first weight to the first microphone based on a distance from the first virtual listening position to the first microphone; receiving, from the first computing device, audio from the plurality of microphones in the first meeting location; prioritizing audio received from the first microphone over other audio received from the plurality of microphones based on the first weight; and providing the prioritized audio to the second computing device.

Another example of the technology discussed herein relates to a system comprising: a processing system; and memory coupled to the processing system, the memory comprising computer executable instructions that, when executed, perform operations comprising: memory comprising computer executable instructions that, when executed, perform operations comprising: receiving an indication of a virtual meeting session between a first computing device at a first meeting location and a second computing device at a second meeting location, wherein the first computing device is connected to a plurality of microphones positioned in the first meeting location; providing, to the second computing device, an audio map of the first meeting location; receiving, from the second computing device, a selection of a virtual listening position on the audio map; correlating the virtual listening position to a first microphone of the plurality of microphones; receiving, from the first computing device, audio from the plurality of microphones in the first meeting location; prioritizing audio received from the first microphone over other audio received from the plurality of microphones; and providing the prioritized audio to the second computing device.

Another example of the technology discussed herein relates to a computer-readable medium storing instructions that, when executed by a computer, cause the computer to: receive an indication of a virtual meeting session between a first computing device at a first meeting location and a second computing device at a second meeting location, wherein the first computing device is connected to a plurality of microphones positioned in the first meeting location; provide, to the second computing device, an audio map of the first meeting location; receive, from the second computing device, a selection of a virtual listening position on the audio map; correlate the virtual listening position to a first microphone and a second microphone of the plurality of microphones; receive, from the first computing device, audio from the plurality of microphones in the first meeting location; prioritize audio received from the first microphone and the second microphone over other audio received from the plurality of microphones; and provide the prioritized audio to the second computing device.

Aspects of the present disclosure, for example, are described above with reference to block diagrams and/or operational illustrations of methods, systems, and computer program products according to aspects of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

The description and illustration of one or more aspects provided in this application are not intended to limit or restrict the scope of the disclosure as claimed in any way. The aspects, examples, and details provided in this application are considered sufficient to convey possession and enable others to make and use the best mode of claimed disclosure. The claimed disclosure should not be construed as being limited to any aspect, example, or detail provided in this application. Regardless of whether shown and described in combination or separately, the various features (both structural and methodological) are intended to be selectively included or omitted to produce an embodiment with a particular set of features. Having been provided with the description and illustration of the present application, it is envisioned that variations, modifications, and alternate aspects fall within the spirit of the broader aspects of the general inventive concept embodied in this application do not depart from the broader scope of the claimed disclosure.

We claim:

1. A method, comprising:
receiving an indication of a virtual meeting session between a first computing device at a first meeting location and a second computing device at a second meeting location, wherein the first computing device is connected to a plurality of microphones positioned in the first meeting location;
providing, to the second computing device, an audio map of the first meeting location;
receiving, from the second computing device, a selection of a first virtual listening position on the audio map;
correlating the selected first virtual listening position to a first microphone of the plurality of microphones by assigning a first weight to the first microphone based on a distance from the first virtual listening position to the first microphone;
receiving, from the first computing device, audio from the plurality of microphones in the first meeting location;
prioritizing audio received from the first microphone over other audio received from the plurality of microphones based on the first weight; and
providing the prioritized audio to the second computing device.

2. The method of claim 1, wherein prioritizing the audio received from the first microphone comprises causing the audio received from the first microphone to be output by a speaker at an increased level over the other audio received from the plurality of microphones.

3. The method of claim 2, wherein correlating the selected first virtual listening position to the first microphone further comprises:
correlating the first virtual listening position to the first microphone and a second microphone of the plurality of microphones;
assigning a second weight to the second microphone based on a distance from the first virtual listening position to the second microphone; and
prioritizing the audio received from the second microphone based on the second weight.

4. The method of claim 3, wherein prioritizing the audio comprises:
causing the audio received from the first microphone to be output at a first level based on the first weight; and
causing the audio received from the second microphone to be output at a second level based on the second weight.

5. The method of claim 1, wherein the audio map comprises, for each of the plurality of microphones:
location information about a physical location of the microphone; and
location information about an audio zone corresponding to a spatial area within which the microphone captures audio.

6. The method of claim 5, wherein correlating the selected first virtual listening position to the first microphone comprises determining the first virtual listening position is included in a first audio zone that corresponds to the first microphone.

7. The method of claim 1, further comprising:
including, in the audio map, an indication of the virtual listening position; and
providing the audio map to the first computing device for display in a user interface.

8. The method of claim 1, further comprising:
receiving, from the second computing device, a selection of a second virtual listening position on the audio map;
correlating the selected second virtual listening position to a second microphone of the plurality of microphones;
receiving, from the first computing device, audio from the plurality of microphones in the first meeting location;
prioritizing the audio received from the second microphone; and
providing the prioritized audio to the second computing device.

9. The method of claim 1, wherein:
prior to providing the prioritized audio to the second computing device:
providing the prioritized audio to a language translation service; and
receiving, from the language translation service, the prioritized audio translated from a first language into a second language; and
providing the prioritized audio to the second computing device comprises providing the translated prioritized audio to the second computing device.

10. The method of claim 1, further comprising:
receiving location information about a physical location of a meeting participant in the first meeting location; and
including, in the audio map, an indication of the physical location of the meeting participant in the first meeting location.

11. The method of claim 10, wherein receiving the location information about the physical location of the meeting participant in the first meeting location comprises identifying the meeting participant using at least one of:
facial recognition on a video of the virtual meeting session;
voice recognition on the received audio;
an identification badge; or
manual input of the meeting participant's identity.

12. The method of claim 1, further comprising:
receiving, from the second computing device, audio from a microphone in the second meeting location;
determining a speaker in the first meeting location is located proximate to the first microphone; and
causing the audio received from the microphone in the second meeting location to be output by the speaker located proximate to the first microphone.

13. A system, comprising:
a processing system; and
memory comprising computer executable instructions that, when executed, perform operations comprising:
receiving an indication of a virtual meeting session between a first computing device at a first meeting location and a second computing device at a second meeting location, wherein the first computing device is connected to a plurality of microphones positioned in the first meeting location;
providing, to the second computing device, an audio map of the first meeting location;
receiving, from the second computing device, a selection of a virtual listening position on the audio map;
correlating the virtual listening position to a first microphone of the plurality of microphones;
receiving, from the first computing device, audio from the plurality of microphones in the first meeting location;
prioritizing audio received from the first microphone over other audio received from the plurality of microphones; and
providing the prioritized audio to the second computing device.

14. The system of claim 13, wherein prioritizing the audio received from the first microphone comprises causing the audio received from the first microphone to be output at an increased clarity over the other audio received from the plurality of microphones.

15. The system of claim 13, wherein:
the audio map comprises, for each of the plurality of microphones:
location information about a physical location of the microphone; and
location information about an audio zone corresponding to a spatial area within which the microphone effectively captures audio; and
correlating the virtual listening position to the first microphone comprises determining the virtual listening position is included in a first audio zone that corresponds to the first microphone.

16. The system of claim 13, wherein correlating the virtual listening position to the first microphone further comprises:
determining the virtual listening position is in a first audio zone corresponding to the first microphone and a second audio zone corresponding to a second microphone of the plurality of microphones;
correlating the virtual listening position to the first microphone and the second microphone, comprising:
assigning a first weight to the first microphone based on a distance from the virtual listening position to the first microphone; and
assigning a second weight to the second microphone based on a distance from the virtual listening position to the second microphone; and
prioritizing the audio received from the first microphone and the second microphone, comprising:
causing the audio received from the first microphone to be output at a first level based on the first weight; and
causing the audio received from the second microphone to be output at a second level based on the second weight.

17. The system of claim 13, further comprising:
including, in the audio map, an indication of the virtual listening position; and
providing the audio map to the first computing device for display in a user interface.

18. The system of claim 13, wherein:
prior to providing the prioritized audio to the second computing device:
providing the prioritized audio to a language translation service; and
receiving, from the language translation service, the prioritized audio translated from a first language into a second language; and
providing the prioritized audio to the second computing device comprises providing the translated prioritized audio to the second computing device.

19. A computer-readable medium storing instructions that, when executed by a computer, cause the computer to:
receive an indication of a virtual meeting session between a first computing device at a first meeting location and a second computing device at a second meeting location, wherein the first computing device is connected to a plurality of microphones positioned in the first meeting location;
provide, to the second computing device, an audio map of the first meeting location;
receive, from the second computing device, a selection of a virtual listening position on the audio map;
correlate the virtual listening position to a first microphone and a second microphone of the plurality of microphones;
receive, from the first computing device, audio from the plurality of microphones in the first meeting location;
prioritize audio received from the first microphone and the second microphone over other audio received from the plurality of microphones; and
provide the prioritized audio to the second computing device.

20. The computer-readable medium of claim 19, wherein:
correlating the virtual listening position to the first microphone and the second microphone comprises:
assigning a first weight to the first microphone based on a distance from the virtual listening position to the first microphone; and
assigning a second weight to the second microphone based on a distance from the virtual listening position to the second microphone; and
prioritizing the audio received from the first microphone and the second microphone comprises:
causing the audio received from the first microphone to be output at a first level based on the first weight; and
causing the audio received from the second microphone to be output at a second level based on the second weight.
